(19) United States
(12) Patent Application Publication
(10) Pub. No.: US 2003/0039865 A1
(43) Pub. Date: Feb. 27, 2003

(54) Isotopically engineered optical materials

(75) Inventors: Vic Kelsey, Wilmington, DE (US); James E. Alexander, Evergreen, CO (US); Stephen J. Burden, Golden, CO (US)

Correspondence Address: SHERIDAN ROSS PC, 1560 BROADWAY, SUITE 1200, DENVER, CO, 80202

(73) Assignee: Isonics Corporation, Golden, CO

(21) Appl. No.: 10/177,579

(22) Filed: Jun. 20, 2002

Related U.S. Application Data
(60) Provisional application No. 60/300,004, filed on Jun. 20, 2001.

(51) Int. Cl. B32B 9/04

(52) U.S. Cl. 428/696; 428/446; 428/704

(57) ABSTRACT

The present invention is directed to isotopically enriched optical materials and methods of producing the same. The optical materials provide high isotopic purity silica, calcium, zinc, gallium and germanium materials with increased resistance to optical damage which can be used alone or in combination with other means of preventing damage to decrease lens degradation caused by energy-induced compaction during use.

### CROSS-REFERENCE TO RELATED APPLICATIONS

This application claims the benefit of U.S. Provisional Application No. 60/300,004 filed Jun. 20, 2001, which is incorporated herein in its entirety by this reference.

### FIELD OF THE INVENTION

This invention relates to isotopically enriched optical materials having increased resistance to radiation-induced damage.

### BACKGROUND OF THE INVENTION

As the energy and power output of lasers increase, the optics such as lenses, prisms, and windows, which are used in conjunction with such lasers, are exposed to increased irradiation levels and energies. Fused silica's ability to transmit ultraviolet (UV) radiation has caused this synthetic material to receive increasing attention as the manufacturing material for optics in high-energy laser systems. Fused silica lenses have found a variety of uses in applications requiring transmission of UV radiation at wavelengths below 300 nm and with an intensity of 100 mJ/cm²/pulse or greater. Of particular interest are short wavelength excimer lasers operating in the UV wavelength ranges.

The continuous improvement in finer circuitry in personal computers and other electronic equipment is a result of the explosion in the fabrication of semiconductor circuit components that is largely attributable to the steady advancements in optical microlithography, the method by which transistors and memory modules are created on silicon wafers. Advances in miniaturization and improved performance in integrated circuits are directly related to the spatial resolution of the optical systems employed in their fabrication. In order to “write” smaller features on microchips, light of shorter and shorter wavelengths has been required in the photolithography process. This in turn has forced the development of optical materials that can operate in the wavelengths employed in the new microlithographic systems. In the early 1980's ultrahomogeneous glasses were developed to handle the 365 nm “i” line of mercury light sources. Later, fused silica was developed to withstand the higher power densities and higher transmittance requirements associated with the KrF 248 nm lasers. However, in shifting to the 193 nm ArF lasers, the performance limit of fused silica was approached leading to “compaction” or aberrations in index of refraction on the ppm scale as a result of interaction between the light and bonding flaws in the silica.

It is known that such laser induced degradation adversely affects the optical properties and performance of the fused silica optics by decreasing light transmission levels, discoloring the glass, altering the index of refraction, altering the density, and increasing absorption levels of the glass.

Although the exact origin, nature and mechanism of formation of the centers that give rise to absorptions in fused silica are not completely understood, these defects can be identified and tracked by optical absorption and/or electron spin resonance techniques.

Two categories of defects can be described: the E′ center at about 210 nm and an oxygen related defect, having an absorption at about 260 nm with a corresponding fluorescence at 650 nm. The E′ defect structure consists of a paramagnetic electron trapped in a dangling silicon orbital projecting into interstitial space. As the E′ center has an unpaired electron, it is detectable by electron spin resonance spectroscopy. The induced E′ center has a 5.8 eV (210 nm) absorption band and a 2.7 eV (458 nm) fluorescence band. The absorption at 210 nm is particularly deleterious in ArF (193 nm) laser applications as it tails into the irradiating wavelength region of the laser. For applications such as lenses for 193 nm microlithography it is important to minimize or eliminate any optical absorption in this region of the UV spectrum.

The structure of fused silica is best described as amorphous, that is, a rigid solid, but with no long range order. It is composed of building blocks of silicon ions surrounded by four oxygen ions in tetrahedral symmetry in a bonding scheme described as an sp³ hybrid orbital. These “silica tetrahedra” form the building block of fused silica or glassy silica. The equilibrium alignment of these tetrahedra during crystallization from the molten state is well known to take longer than other ceramic based compounds because of the steric hindrance of the silica tetrahedra of silicates, in general, and specifically pure SiO₂. Therefore, there is no observed transition from liquid to solid, but rather a gradual increase in viscosity of the material with a decrease in temperature. This silicon-oxygen bond in the sp³ hybrid orbital is very strong, and is largely covalent in nature. However, there is a small ionic component to the silicon-oxygen bond that relies upon fundamental vibrations that are mass related. It is argued, therefore, that structural flaws such as the E′ defect are largely influenced by local deviations in mass introduced by the isotopic make-up of the silicon and oxygen ions.

Many methods have been suggested for improving the optical damage resistance of fused silica glass. It has been generally known that high purity fused silica prepared by methods such as flame hydrolysis, CVD-soot remelting process, plasma CVD process, electrical fusing of quartz crystal powder, and other methods, are susceptible to laser damage to various degrees.

This variable propensity to laser damage has been attributed to low OH content, sometimes measuring as low as 10 ppm or less. As a result, the most common suggestion has been to increase the OH content of such glass to a high level. For example, Escher, G. C., KrF Laser Induced Color Centers In Commercial Fused Silicas, SPIE Vol. 998, Excimer Beam Applications, pp.30-37 (1988), confirms that defect generation rate is dependent upon the fused silica OH content, and that “wet” silicas are the material of choice for KrF applications. Specifically, they note that high OH content silicas are more damage resistant than low OH silicas. For example, U.S. Pat. No. 5,086,352 and related U.S. Pat. No. 5,325,230 show that for high purity silica glass having low OH content, KrF excimer laser durability is poor. Thus, they suggest having an OH content of at least 50 ppm. Similarly, Yamagata, S., Improvement of Excimer Laser Durability of Silica Glass, Transactions of the Materials Research Society of Japan, Vol.8, pp. 82-96, 1992, discloses the effect of dissolved hydrogen on fluorescence emission behavior and the degradation of transmission under irradiation of KrF excimer laser ray for high purity silica glass containing OH groups to 750 ppm by weight such as those synthesized from high purity silicon tetrachloride by the oxygen flame hydrolysis method.

Others methods of increasing the optical durability of fused silica have been suggested. For example, Faile, S. P., and Roy, D. M., Mechanism of Color Center Destruction in Hydrogen Impregnated Radiation Resistant Glasses, Materials Research Bull., Vol.5, pp. 385-390, 1970, have disclosed hydrogen-impregnated glasses that resist gamma ray-induced radiation. Japanese Patent Abstract 40-10228 discloses a process by which quartz glass is made by melting at about 400° C. to 1000° C. in an atmosphere containing hydrogen to prevent colorization due to the influence of ionizing radiation (solarization). Similarly, Japanese Patent Abstract 39-23850 teaches that the transmittance of UV light by silica glass is improved by heat-treating the glass in a hydrogen atmosphere at 950 to 1400° C. followed by heat treatment in an oxygen atmosphere at the same temperature range.

Shelby, J. E., Radiation Effects in Hydrogen-impregnated Vitreous Silica, J. Applied Physics, Vol. 50, No. 5, pp. 3702-06 (1979), suggests that irradiation of hydrogen-impregnated vitreous silica suppresses the formation of optical defects, but that hydrogen impregnation also results in the formation of large quantities of bound hydroxyl and hydride, and also results in the expansion or decrease in density of the glass.

Recently, U.S. Pat. No. 5,410,428 disclosed a method of improving resistance to UV laser light degradation and preventing induced optical degradation by a combination of treatment processes and compositional manipulations of the fused silica members to achieve a particular hydrogen concentration and refractive index. Under UV irradiation the chemical bonding between silicon and oxygen in the network structure of the fused silica is generally broken and then rejoins with other structures resulting in an increased local density and an increased local refractive index of the fused silica at the target area.

U.S. Pat. No. 5,616,159 to Araujo et al, disclosed a high purity fused silica having high resistance to optical damage up to 10⁷ pulses (350 mJ/cm²) at the laser wavelength of 248 nm, and a method for making such glass.

U.S. Pat. No. 5,896,222 teaches a method of producing a fused silica lens that transmits ultraviolet radiation having a wavelength below 300 nm with controlled optical damage and inhibited red fluorescence during such transmission. The method uses thermal conversion of a polymethylsiloxane precursors to fused silica particles followed by consolidation of the particles into a body and formation of an optical lens from the fused silica body.

More recently, U.S. Pat. No. 6,205,818 disclosed a method of increasing the resistance of fused silica to optical damage by pre-compacting the glass by either irradiating the glass with a high pulse fluence laser, subjecting the glass to a hot isostatic press operation, or exposing the glass to a high energy electron beam and subsequently treating the glass in a hydrogen atmosphere to remove any absorptions at 215 and 260 nm which may have been created by the electron beam.

While the above suggested methods are partially effective in reducing the absorption induced at 215 and 260 nm, there has been little or no suggestion for addressing optical damage caused by radiation-induced compaction resulting from prolonged exposure at all wavelengths. Thus, there continues to be a need for improved fused silica glasses and methods for increasing their resistance to optical damage during prolonged exposure to laser radiation, in particular, resistance to optical damage associated with prolonged exposure to radiation at wavelengths across the entire light spectra.

### SUMMARY OF THE INVENTION

Accordingly, the present invention provides high isotopic purity silica and calcium, zinc, gallium and germanium materials with increased resistance to optical damage which can be used alone or in combination with any of the above described methods to decrease lens damage caused by energy-induced compaction during use.

One aspect of the present invention discloses a method of producing a fused silica lens with superior resistance to radiation-induced damage comprising contacting an isotopically-enriched silicon compound selected from the group consisting of trichlorosilane and octamethylcyclotetrasiloxane, with an oxidizing atmosphere to produce fused isotopically-enriched SiO₂ and degassing the fused isotopically-enriched SiO₂. The fused silica is then shaped into a lens having the desired specifications.

Another aspect of the present invention discloses a method of producing a fused silica lens with superior resistance to radiation-induced damage by decomposing an isotopically-enriched silicon halide to form a SiO₂ soot and degassing the isotopically-enriched SiO₂ soot. The fused silica is then shaped into a lens having the desired specifications.

Another aspect of the present invention discloses a method of producing a fused silica lens with superior resistance to radiation-induced damage by contacting an isotopically-enriched silicon alkoxide having the general formula Si(OR)₄, wherein R is an alkyl group, with water to form an isotopically enriched silicon dioxide gel. The gel is subsequently dried and thermally processed to form the isotopically-enriched fused silica. The fused silica is then shaped into a lens having the desired specifications.

Another aspect of the present invention discloses a method of producing a calcium fluoride lens with superior thermal conductivity by blending an aqueous slurry of isotopically-enriched CaCO₃ with a stochiometric amount of hexafluosilicic acid to form solid CaF₂ and melting the CaF₂ in a vacuum furnace to grow single CaF₂ crystals. The CaF₂ crystals are then shaped into a lens having the desired specifications.

Another aspect of the present invention discloses a method of producing a zinc sulfide lens with superior thermal conductivity by dissolving isotopically-enriched ZnO in an aqueous nitric acid solution and bubbling H₂S gas through the solution to form a ZnS precipitate. The ZnS precipitate is then hot-pressed to form a ZnS solid which is shaped into a lens having the desired specifications.

Another aspect of the present invention discloses a method of producing a zinc selenium lens with superior thermal conductivity by dissolving isotopically-enriched ZnO in an aqueous nitric acid solution and bubbling H₂Se gas through the solution to form a ZnSe precipitate. The ZnSe precipitate is then hot-pressed to form a ZnSe solid which is shaped into a lens having the desired specifications.

Another aspect of the present invention discloses a method of producing a single crystal germanium lens with superior thermal conductivity by growing single crystals of germanium from isotopically-enriched germanium melts by the standard Czochralski method and then shaping the single crystals of germanium into a lens having the desired specifications.

Another aspect of the present invention discloses a method of producing a single crystal gallium arsenide lens with superior thermal conductivity by growing single crystals of gallium arsenide from isotopically-enriched gallium melts by the standard Czochralski method and then shaping the single crystals of gallium arsenide into a lens having the desired specifications.

Another aspect of the present invention provides a fused silica lens having superior resistance to radiation-induced damage composed of isotopically-enriched SiO₂. The silicon of the lens is a silicon isotope enriched to at least 95%.

Another aspect of the present invention provides a CaF₂ lens having superior thermal conductivity. The calcium in the lens is isotopically-enriched to at least 97%.

Another aspect of the present invention provides a ZnS lens having superior thermal conductivity. Either or both of the zinc and sulfur elements in the lens may be isotopically enriched to at least 96%.

Another aspect of the present invention provides a ZnSe lens having superior thermal conductivity. Either or both of the zinc and selenium elements in the lens may be isotopically enriched to at least 96%.

Another aspect of the present invention provides a germanium lens having superior thermal conductivity. The germanium in the lens is isotopically-enriched to at least 90%.

Another aspect of the present invention provides a gallium arsenide lens having superior thermal conductivity. The gallium in the lens is isotopically-enriched to at least 90%.

### DETAILED DESCRIPTION OF THE INVENTION

Isotopic enrichment or separation processes are well known to those of skill in the art and include gaseous diffusion, gas centrifuge, chemical exchange, chemical distillation, and electromagnetic separation. Each method has its advantages and disadvantages, and the selection of a specific process for any given element will be dependent upon factors such cost, efficiency, and availability. The field is described in the following reference texts: (1) Isotopes in the Physical and Biomedical Sciences, Buncel and Jones, Eds, Amsterdam, Elsevier Publishers, 1987, (2) Inorganic Isotopic Synthesis, Herber, R. H., Ed, W. A. Benjamin, Publishers, New York, 1962, and (3) Nuclear Methods in Minerology, and Geology: Techniques and Apllications, Vertes, Nagy and Suvegh, Eds, Plenum Press, New York, 1998.

Isotopically-Enriched Silicon Optical Materials

One means of increasing the thermal conductivity in a material to enhance the resistance to radiation damage is via the use of isotopically enriched materials. Isotopically-enriched means any isotope of an element that is present in an amount greater than is found naturally occurring. For instance, natural silicon contains three isotopes, ²⁸Si (92%), ²⁹Si (5%) and ³⁰Si (3%). An otherwise perfect crystal of silicon will contain imperfections in the form of isotopes of different mass with the density of these imperfections amounting to nearly 8%. Table 1 shows the concentration of the typical impurities that cause these imperfections. This level of impurities far exceeds the doping levels and density of imperfections ordinarily found in device-quality crystals.

TABLE 1
Concentration of Impurities in Silicon Crystals.

| | Concentration |
|---|---|
| | (atoms per |
| Impurity Type | cm³) |
| Dopant atoms | 10¹⁴ to 10¹⁸ |
| Heavy Metals | 10¹² to 10¹³ |
| Oxygen | 5-10 × 10¹⁷ |
| ²⁹Si and ³⁰Si | 4 × 10²¹ |

By removing the minority isotopes, isotopically-enriched silicon-28 crystals have a more perfect crystal lattice that generates less heat and electromagnetic noise, and have a higher thermal conductivity that more efficiently dissipates the heat that is generated. The mechanisms for this improvement are reduced phonon-phonon and phonon-electron interactions. The thermal conductivity of isotopically pure silicon-28 thin films has been measured to be 60% greater than natural silicon at room temperature and 40% greater at 100° C. by Capinski et al (Thermal Conductivity of Isotopically Enriched Silicon, Applied Physics Letters 71(15):2109 (1997)). This result has been confirmed with small diameter, bulk, single crystals of silicon-28 at the Max Planck Institute (T. Ruf, et al. Thermal 5 Conductivity of Isotopically Enriched Silicon, Solid State Communications, 115(5):243 (2000)).

Similarly, oxygen has three stable naturally occurring isotopes, ¹⁶O(99.785%), ¹⁷O (0.038%), and ¹⁸O (0.204%). While the percentage of ¹⁶O is predominant, the contribution of the other two isotopes on an optical level is very significant, and the resulting changes in the index of refraction are significant to high-resolution optical systems.

The structure of fused silica is best described as amorphous, but with no long-range order. It is composed of building blocks of silicon ions surrounded by four oxygen ions in tetrahedral symmetry in a bonding scheme described as an sp³ hybrid orbital. These “silica tetrahedra” form the building block of fused silica or glassy silica.

The equilibrium alignment of these tetrahedra during crystallization from the molten state is well known to take longer than other ceramic-based compounds because of the steric hindrance of the silica tetrahedra of silicates in general, and specifically of pure SiO₂. Therefore, there is no observed transition from liquid to solid, but rather a gradual increase in viscosity of the material with a decrease in temperature. This silicon-oxygen bond in the sp³ hybrid orbital is very strong, and is largely covalent in nature. However, there is a small ionic component to the silicon-oxygen bond that relies upon fundamental vibrations that are mass related. It is therefore argued that structural flaws (such as the E′ defect) are largely influenced by local deviations in mass introduced by the isotopic make-up of the silicon and oxygen ions.

By utilizing a precursor comprising a single isotope of silicon (²⁸Si, ²⁹Si or ³⁰Si), in combination with naturally occurring oxygen or a single isotope of oxygen (¹⁶O, ¹⁷O, or ¹⁸O) in the formation of SiO₂, a fused silica product can be fabricated that has significantly fewer E′ defects. This material is fused or melted to produce a blank or lens that has significantly improved resistance to radiation damage from ultra violet mercury lamps used in lithography as well as KrF and ArF eximer lasers used in high precision lithographic systems.

Several methods of fabricating isotopically enriched silicon optical materials are useful. In one embodiment of the present invention, SiCl₃H or trichlorosilane (TCS) is thermally decomposed in a slightly oxidizing atmosphere to produce a SiO₂ or silica soot. The silicon in the TCS is isotopically-enriched to greater than 95% and preferably to greater than 97%, more preferably to greater than 98%. Most preferably, the silicon is isotopically-enriched to greater than 99% ²⁸Si in the TCS.

The silicon soot is then slowly heated in a resistance heated vacuum furnace to 1700° C. for 6 hours to promote the degassing of the fused, isotopically-enriched SiO₂. The fused silica molten mass is cooled at 100° C. per hour to room temperature. The fused silica glass blank is then ground to any desired lens specifications.

In another embodiment of the present invention, octamethylcyclotetrasiloxanne ([SiO(CH₃)₂]₄) having an isotopically-enriched Si portion is used in place of TCS in order to reduce residual halides in the fused silica. Thus, isotopically-enriched octamethylcyclotetrasiloxanne is thermally decomposed in a slightly oxidizing atmosphere to produce a SiO₂ or silica soot. The silicon in the octamethylcyclotetrasiloxanne is isotopically-enriched to greater than 95% and preferably to greater than 97%, more preferably to greater than 98%. Most preferably, the silicon in the octamethylcyclotetrasiloxanne is isotopically-enriched to greater than 99% ²⁸Si. The soot is then slowly heated in a resistance heated vacuum furnace to 1700° C. for 6 hours to promote the degassing of the fused, isotopically-enriched SiO₂. The fused silica molten mass is cooled at 100° C. per hour to room temperature. The fused silica glass blank is then shaped to any desired lens specifications. Shaping can take the form of polishing, grinding, cutting or any other physical manipulation applied to transform the bulk isotopically-enriched optical materials of the present invention into a lens meeting the desired technical specifications.

In another embodiment, SiF₄ or SiCl₄, is injected into a stream of carrier gas (such as argon, nitrogen, helium) in a thermal plasma which contains oxygen. The silicon in the gas is isotopically-enriched to greater than 95% and preferably to greater than 97%, more preferably to greater than 98%. Most preferably, the silicon in the gas is isotopically-enriched to greater than 99% ²⁸Si. The SiF₄ or SiCl₄ gasses are thermally decomposed to form SiO₂ or silica soot that can be processed as described above to yield a fused silica blank. Similarly, the isotopically-enriched SiF₄ and SiCl₄ can be oxidized in a flame or torch in which a fuel such as propane, acetylene, natural gas or some other gaseous fuel is ignited. The combusting flame thermally decomposes the SiF₄ or SiCl₄ to form a SiO₂ or silica soot suitable for processing as described above to yield a fused silica blank which can be shaped to any desired lens specifications.

In another embodiment of the present invention, SiF₄ or other silicon-containing compounds comprising isotopically-enriched silicon, are converted into an alkoxide form with the general formula Si(OR)₄, where R is an alkyl group. Alternatively, the silicon alkoxides can be purchased commercially. The alkyl group can be aliphatic hydrocarbons which can be straight, branched or cyclic and optionally substituted with one or more sutstituents such as a halogen, alkenyl, aklynyl, aryl, hydroxy, amino, thio, alkoxy, carboxy, oxo or cycloaklyl. The most common of these are tetramethyl orthosilicate (Si(OCH₃)₄), and tetraethyl orthosilicate (Si(OCH₂CH₃)₄). However, many other alkoxides containing various organic functional groups can be used. The silicon in the alkoxide is isotopically-enriched to greater than 95% and preferably to greater than 97%, more preferably to greater than 98%. Most preferably, the silicon in the alkoxide is isotopically-enriched to greater than 99% ²⁸Si. This type of ‘sol-gel’ processing is well known in the ceramics/chemical industry. An SiO₂ gel is produced by reacting the alkoxide with water in the following reaction:

Si(OCH₂CH₃)₄(Liq)+2H₂O?SiO₂(Solid)+4 HOCH₂CH₃(Liq)

The gel is dried and thermally processed to form an enriched silica blank. The thermal treatment can be performed by venting the ethanol above its critical point or by prior solvent exchange with CO₂ followed by supercritical venting. It is imperative that this process only be performed in an autoclave specially designed for this purpose. For example, small autoclaves used by electron microscopists to prepare biological samples are acceptable for CO₂ drying. The process is performed by placing the alcogels in the autoclave which has been filled with ethanol. The system is pressurized to at least 750-850 psi with CO₂ and cooled to 5-10° C. Liquid CO₂ is then flushed through the vessel until all the ethanol has been removed from the vessel and from within the gels. When the gels are ethanol-free, the vessel is heated to a temperature above the critical temperature of CO₂ (31° C.). As the vessel is heated, the pressure of the system rises. CO₂ is carefully released to maintain a pressure slightly above the critical pressure of CO₂ (1050 psi). The system is held at these conditions for a short time, followed by the slow, controlled release of CO₂ to ambient pressure. As with previous steps, the length of time required for this process is dependent on the thickness of the gels. The process may last anywhere from 12 hours to 6 days. The dried gel is then slowly heated to between about 1300° C. and about 1800° C. in air to coalesce the powder into a blank. The fused silica glass blank is then shaped to any desired lens specifications.

Isotopically Enriched Calcium Fluoride

The next step in the evolution of microlithography is in the projected use of 157 nm lasers that will allow the lower limit on a microchip feature to approach 70 nm. In this application only CaF₂ lenses have the transmittance qualities at that wavelength and the chemical stability to operate in that environment.

As wavelengths become smaller and energy per unit area through the lens material becomes greater, it is expected that the sensitivity to minor flaws leading to thermally induced damage, even in CaF₂, will also increase. Minor stacking faults and impurities that are inevitable will likely cause localized heating at the site of the flaw. If the heat cannot be dissipated, it will affect an alteration in structure resulting in a change in optical character. Therefore, it is beneficial to fabricate a CaF₂ lens from materials that exhibit enhanced thermal conductivity.

The CaF₂ material subjected to the high power density associated with the relatively high energy (low wavelength) 157 nm laser is sensitive to even slight aberrations that are inherent in the material. These slight imperfections generate heat under continuous use, altering the local structure and ultimately leading to a change in the index of refraction. This phenomenon can cascade rapidly as a result of the high power densities involved. It is therefore imperative to dissipate any heat generated within the CaF₂ microlithographic lens. A CaF₂ lens with isotopically-enriched Ca can be fabricated to yield a material with a superior thermal conductivity over a CaF₂ lens fabricated from naturally occurring calcium. This results in a lens with superior radiation damage resistance.

The element calcium has six stable isotopes: (1) ⁴⁰Ca-96.94%, (2) ⁴²Ca-0.647%, (3)⁴³Ca-0.135%, (4) ⁴⁴Ca-2.09%, (5) ⁴⁶Ca-0.0035%, and ⁴⁸Ca-0.187%. Fluorine has only one stable isotope, ¹⁹F. As shown previously in the case of silicon, the thermal conductivity in CaF₂ fabricated with isotopically enriched calcium yields a material with a superior thermal conductivity over CaF₂ fabricated with naturally occurring calcium.

An isotopically-enriched CaF₂ lens can be fabricated by blending a slurry of CaCO₃ with a stochiometric amount of hexafluosilicic acid (H₂SiF₆). The calcium component of the calcium carbonate is isotopically-enriched with any one of the six stable isotopes of calcium. The calcium in the calcium carbonate is isotopically-enriched to greater than 97% and preferably to greater than 99%. Most preferably, the calcium is isotopically-enriched to greater than 99% ⁴⁰Ca to produce a ⁴⁰CaF₂ lens. The pH of the slurry is adjusted to between 4 and 6 via the addition of ammonium hydroxide or an alkali metal hydroxide. The isotopically-enriched CaF₂ formed via precipitation can then be filtered from the aqueous slurry, and subsequently dried. The resulting isotopically-enriched CaF₂ powder is melted in a vacuum furnace and single crystals are grown by seed growth from a melt at about 1500° C. The crystals are shaped to appropriate thickness and ground or polished to achieve the proper optical quality.

Isotopically Enriched Infrared Fabrication Materials

Polycrystalline materials such as ZnS and ZnSe, as well as single crystal germanium (Ge) and gallium arsenide (GaAs) are used in optical systems that require transmission in the infrared (IR) regions ranging in wavelength from 1.0 to 15 microns. In some instances, specifically in ZnS, where extreme care is taken in the hot-pressing fabrication process to eliminate pores and other defects, the material also has transparency in the visible region. ZnS and ZnSe are sometimes used as coatings on other IR transparent materials to improve durability.

All IR transmissive materials and/or lenses have some degree of absorption of radiant energy. This adsorption is often manifested by the generation of heat. If the thermal conductivity of the material is not sufficient to take away the heat generated, the onset of localized structural damage will occur, leading to a cascading effect of increased adsorption followed by more damage. The optical quality of the IR device will eventually be compromised until the part will need to be replaced, or may fail to perform optimally in a “one-time” mission or operation. IR lenses fabricated with isotopically enriched elements yield a material with a superior thermal conductivity over similar compositions fabricated with naturally occurring elements, resulting in a lens with superior radiation damage resistance.

Naturally occurring zinc has five stable isotopes: (1) ⁶⁴Zn-48.6%, (2) ⁶⁶Zn-27.9%, (3) ⁶⁷Zn-4.1%, (4) ⁶⁸Zn-18.8%, and (5) ⁷⁰Zn-0.62%. Other elements that combine with zinc to form infrared transmissive materials (IR lenses) are sulfur, and selenium. Sulfur has four stable isotopes: (1) ³²S-95.02%, (2) ³³S-0.75%, (3) ³⁴S-4.21%, and (4) ³⁶S-0.017%. Selenium has five stable isotopes: (1) ⁷⁴Se-0.9%, (2) ⁷⁶S-9.0%, (3) ⁷⁷Se-7.6%, (4) ⁷⁸Se-23.5%, (5) ⁸⁰Se-49.8%, and (6) ⁸²Se-9.2%. has five stable isotopes: (1) ⁷⁰Ge-20.5%, (2) ⁷²Ge- 27.4%, (3) ⁷³Ge-7.8%, (4) ⁷⁴Ge-36.5%, and (5) ⁷⁶Ge-7.8%. In the material gallium arsenide, arsenic has only one stable isotope, ⁷⁵As, whereas gallium contains two: (1) ⁶⁹Ga-60.1%, and (2) ⁷¹Ga-39.9%.

IR lenses can be fabricated from these isotopically-enriched materials by several methods. In one embodiment, zinc oxide (ZnO) containing isotopically enriched zinc is dissolved in an aqueous nitric acid solution in a reactor under a slight vacuum. Any one of the five stable isotopes of zinc may be used in this process. The zinc material is isotopically-enriched to greater than 80%, preferably greater than 90%, more preferably greater than 95% and even more preferably greater than 99%. Most preferably, the zinc oxide starting material comprises greater than 99% ⁶⁴Zn. After adjusting the pH of the solution to about 3.0 with ammonium or an alkali metal hydroxide, H₂S gas is bubbled into the reactor. Any one of the four stable isotopes of zinc may be used in this step. The sulfur is isotopically-enriched to greater than 96%, preferably greater than 98%, and even more preferably greater than 99%. Most preferably, the sulfur in the H₂S gas is greater than 99% ³²S. The zinc sulfide is precipitated, filtered from the solution and dried. The powder is then sized to narrow the distribution and to take out the coarse tail (particle size greater than 2 microns). The powder is then hot-pressed under vacuum at about 1400° C. at pressure of 3.5×10⁴ KPa for 1 hour. The resulting zinc sulfide solid can then be shaped to desired lens specifications.

In another embodiment, an IR lens of isotopically-enriched zinc selenium is formed. To form this optical material, isotopically-enriched H₂Se gas is used instead of the H₂S in the method of making a zinc sulfide IR lens described above. In this embodiment, any one of the five stable isotopes of Se can be used to form the isotopically-enriched Se portion of the gas. The selenium in the H₂Se is isotopically-enriched to greater than 80%, preferably greater than 90%, more preferably greater than 95% and even more preferably greater than 99%. Most preferably, the H₂Se gas comprises greater than 99% ⁸⁰Se. This method produces an isotopically-enriched ZnSe powder that can be processed to form a solid lens material. The powder is sized to narrow the distribution and to take out the coarse tail, hot-pressed under vacuum and then shaped to desired lens specifications.

In another embodiment, single crystals of germanium (Ge) or gallium arsenide (GaAs) are grown from melts via standard methods well known to those in the art such as the Czochralski method. See P. Hartman, Crystal Growth: An Introduction, (North Holland pub. Co., 1973); and Aspects of Crystal Growth, (Robert A. Lefever ed., M. Dekker, 1971). Briefly described, the Czochralski process involves melting a charge of a high-purity polycrystalline element in a quartz crucible located in a specifically designed furnace. After the heated crucible melts the charge, a crystal lifting mechanism lowers a seed crystal into contact with the molten charge. The mechanism then withdraws the seed to pull a growing crystal from the melt. After formation of a crystal neck, the typical process enlarges the diameter of the growing crystal by decreasing the pulling rate and/or the melt temperature until a desired diameter is reached. By controlling the pull rate and the melt temperature while compensating for the decreasing melt level, the main body of the crystal is grown so that it has an approximately constant diameter (i.e., it is generally cylindrical). Near the end of the growth process but before the crucible is emptied of molten charge, the process gradually reduces the crystal diameter to form an end cone. Typically, the end cone is formed by increasing the crystal pull rate and the heat supplied to the crucible. When the diameter becomes small enough, the crystal is then separated from the melt. During the growth process, the crucible rotates the melt in one direction and the crystal lifting mechanism rotates its pulling cable, or shaft, along with the seed and the crystal, in an opposite direction.

In the embodiment in which isotopically-enriched crystals of germanium are used to form the optical material, the crystal is grown to form any one of the five isotopes of germanium. The germanium material is enriched to greater than 80%, preferably greater than 90%, more preferably greater than 95% and even more preferably greater than 99%. Most preferably, the germanium optical material comprises greater than 99% ⁷⁰Ge. Single crystals of the enriched germanium material are grown as described above and shaped to any desired lens specifications.

In the embodiment in which isotopically-enriched crystals of gallium arsenide are used to form the optical material, the crystal is grown using either of the two isotopes of gallium. The gallium isotope in the GaAs material is enriched to greater than 80%, preferably greater than 90%, more preferably greater than 95% and even more preferably greater than 99%. Most preferably, the gallium in the GaAs optical material comprises greater than 99% ⁶⁹Ga. Single crystals of the isotopically-enriched GaAs material are grown as described above and shaped to any desired lens specifications.

What is claimed is:

1. A method of producing a fused silica lens with superior resistance to radiation-induced damage comprising:
a. contacting an isotopically-enriched silicon compound selected from the group consisting of trichlorosilane and octamethylcyclotetrasiloxanne, with an oxidizing atmosphere to produce fused isotopically-enriched SiO₂;
b. degassing the fused isotopically-enriched SiO₂;
c.shaping the degassed isotopically-enriched fused silica to lens specifications.

2. The method of claim 1, wherein said trichlorosilane comprises a silicon isotope selected from the group consisting of ²⁸Si, ²⁹Si and ³⁰Si.

3. The method of claim 2, wherein said silicon isotope is isotopically enhanced to greater than 93% in said trichlorosilane.

4. The method of claim 2, wherein said silicon isotope is isotopically enhanced to greater than 95% in said trichlorosilane.

5. The method of claim 2, wherein said silicon isotope is isotopically enhanced to greater than 99% in said trichlorosilane.

6. The method of claim 1, wherein the degassing step comprises heating said fused, isotopically-enriched SiO₂ in a resistance heated vacuum furnace to about 1700° C. for about 6 hours.

7. The method of claim 1, wherein said oxidizing atmosphere in said contacting step comprises an oxygen isotope selected from the group consisting of ¹⁶O, ¹⁷O and ¹⁸O.

8. The method of claim 7, wherein said oxygen isotope is enriched to greater than 99.9%.

9. A fused silica lens having superior resistance to radiation-induced damage comprising isotopically-enriched SiO₂ comprising a silicon isotope selected from the group consisting of ²⁸Si, ²⁹Si and ³⁰Si, wherein the concentration of said silicon isotope is greater than 95%.

10. A fused silica lens having superior resistance to radiation-induced damage comprising isotopically-enriched SiO₂ comprising a silicon isotope selected from the group consisting of ²⁸Si, ²⁹Si and ³⁰Si, and an oxygen isotope selected from the group consisting of ¹⁶O, ¹⁷O and ¹⁸O, wherein the concentration of said silicon isotope is greater than 95% and the concentration of said oxygen isotope is greater than 99.9%.

11. A method of producing a fused silica lens with superior resistance to radiation-induced damage comprising:
a. decomposing an isotopically-enriched silicon halide to form a SiO₂ soot;
b. degassing the isotopically-enriched SiO₂ soot; and,
c. shaping the degassed isotopically-enriched fused silica to lens specifications.

12. The method of claim 11, wherein said isotopically enriched silicon halide comprises at least one of SiF₄ and SiCl₄.

13. The method of claim 12, wherein said silicon halide comprises a silicon isotope selected from the group consisting of ²⁸Si, ²⁹Si and ³⁰Si.

14. The method of claim 13, wherein said silicon isotope is enriched to greater than 93%.

15. The method of claim 13, wherein said silicon isotope is enriched to greater than 95%.

16. The method of claim 13, wherein said silicon isotope is enriched to greater than 99%.

17. The method of claim 1, wherein said decomposing step comprises injecting said silicon halide in a stream of carrier gas into a thermal plasma containing oxygen.

18. The method of claim 17, wherein said carrier gas is selected from the group consisting of argon, nitrogen and helium.

19. The method of claim 11, wherein said decomposing step comprises oxidizing said silicon halide in a flame.

20. The method of claim 19, wherein said flame is produced by the combustion of at least one of propane, acetylene and natural gas.

21. A method of producing a fused silica lens with superior resistance to radiation-induced damage comprising:
a. contacting an isotopically-enriched silicon alkoxide having the general formula Si(OR)₄, wherein R is an alkyl group having between 1 and 100 carbons, with water to form an isotopically-enriched silicon dioxide gel;
b. thermally processing the isotopically-enriched silicon dioxide gel to form the isotopically-enriched fused silica; and,
c. shaping the degassed isotopically-enriched fused silica to lens specifications.

22. The method of claim 21, wherein said silicon alkoxide is selected from the group consisting of tetra methyl orthosilicate and tetraethyl orthosilicate.

23. The method of claim 21, wherein said silicon alkoxide comprises a silicon isotope selected from the group consisting of ²⁸Si, ²⁹Si and ³⁰Si.

24. The method of claim 23, wherein said silicon isotope is enriched to greater than 93%.

25. The method of claim 23, wherein said silicon isotope is enriched to greater than 95%.

26. The method of claim 23, wherein said silicon isotope is enriched to greater than 99%.

27. A method of producing a calcium fluoride lens with superior thermal conductivity comprising:
a. blending an aqueous slurry of isotopically-enriched CaCO₃ with a stochiometric amount of hexafluosilicic acid to form solid CaF₂;
b. melting said CaF₂ in a vacuum furnace to grow single CaF₂ crystals; and,
c. shaping the isotopically-enriched CaF₂ to lens specifications.

28. The method of claim 27, wherein said isotopically-enriched CaCO₃ comprises a calcium isotope selected from the group consisting of ⁴Ca, ⁴²Ca, 43Ca, ⁴⁴Ca, ⁴⁶Ca and ⁴⁸Ca.

29. The method of claim 28, wherein said calcium isotope is enriched to greater than 97%.

30. The method of claim 28, wherein said calcium isotope is enriched to greater than 98%.

31. The method of claim 28, wherein said calcium isotope is enriched to greater than 99%.

32. The method of claim 28, wherein the pH of said hexafluosilicic acid is adjusted to a pH in the range of about 4 to about 6.

33. The method of claim 28, wherein said vacuum furnace is maintained at a temperature of about 1500° C.

34. A CaF₂ lens having superior thermal conductivity comprising isotopically enriched calcium comprising a calcium isotope selected from the group consisting of ⁴⁰Ca, ⁴²Ca, ⁴³Ca, ⁴⁴Ca, ⁴⁶Ca and ⁴⁸Ca.

35. The CaF₂ lens of claim 34, wherein said calcium isotope is enriched to greater than 97%.

36. The CaF₂ lens of claim 34, wherein said calcium isotope is enriched to greater than 98%.

37. The CaF₂ lens of claim 34, wherein said calcium isotope is enriched to greater than 99%.

38. A method of producing a zinc sulfide lens with superior thermal conductivity comprising:
a. dissolving isotopically-enriched ZnO in an aqueous nitric acid solution;
b. bubbling H₂S gas through said aqueous nitric acid solution to form a ZnS precipitate;
C. hot-pressing said ZnS precipitate to form a ZnS solid; and,
d. shaping said ZnS solid to lens specifications.

39. The method of claim 38, wherein said isotopically-enriched ZnO comprises a zinc isotope selected from the group consisting of ⁶⁴Zn, ⁶⁶Zn, ⁶⁷Zn, ⁶⁸Zn and ⁷⁰Zn.

40. The method of claim 39, wherein said H₂S gas comprises a sulfur isotope selected from the group consisting of ³²S, ³³S, ³⁴S and ³⁶S.

41. The method of claim 40, wherein said sulfur isotope is enriched to greater than 96%.

42. The method of claim 40, wherein said sulfur isotope is enriched to greater than 98%.

43. The method of claim 40, wherein said sulfur isotope is enriched to greater than 99%.

44. The method of claim 40, wherein said the pH of said nitric acid solution is about 3.

45. The method of claim 40, wherein said hot-pressing is conducted under vacuum at about 1400° C.

46. The method of claim 39, wherein said H₂S gas is replaced with H₂Se gas comprising a selenium isotope selected from the group consisting of ⁷⁴Se, ⁷⁶Se, ⁷⁷Se, ⁷⁸Se, ⁸⁰Se and ⁸²Se, to form a ZnSe precipitate.

47. The method of claim 46 wherein said selenium isotope is enriched to greater than 90%.

48. The method of claim 46, wherein said selenium isotope is enriched to greater than 95%.

49. The method of claim 46, wherein said selenium isotope is enriched to greater than 99%.

50. The method of claim 46, wherein said the pH of said nitric acid solution is about 3.

51. The method of claim 46, wherein said hot-pressing is conducted under vacuum at about 1400° C.

52. A ZnS lens having superior thermal conductivity comprising isotopically-enriched zinc comprising a zinc isotope selected from the group consisting of ⁶⁴Zn, ⁶⁶Zn, ⁶⁷Zn, ⁶⁸Zn and ⁷⁰Zn.

53. A ZnS lens having superior thermal conductivity comprising isotopically-enriched sulfur comprising a sulfur isotope selected from the group consisting of ³²S, ³³S, ³⁴S and ³⁶S.

54. A ZnS lens having superior thermal conductivity comprising isotopically enriched ZnS isotope crystals selected from the group consisting of ⁶⁴Zn³²S, ⁶⁴Zn³³S, ⁶⁴Zn³⁴S, ⁶⁴Zn³⁶S, ⁶⁶Zn³²S, ⁶⁶Zn³³S, ⁶⁶Zn³⁴S, ⁶⁶Zn³⁶S, ⁶⁷Zn³²S, ⁶⁷Zn³³S, ⁶⁷Zn³⁴S, ⁶⁷Zn³⁶S, ⁶⁸Zn³²S, ⁶⁸Zn³³S, ⁶⁸Zn³⁴S, ⁶⁸Zn³⁶S,⁷⁰Zn³²S, ⁷⁰Zn³³S, ⁷⁰Zn³⁶S.

55. A ZnSe lens having superior thermal conductivity comprising isotopically-enriched zinc comprising a zinc isotope selected from the group consisting of ⁶⁴Zn, ⁶⁶Zn, ⁶⁷Zn, ⁶⁸Zn and ⁷⁰Zn.

56. A ZnSe lens having superior thermal conductivity comprising isotopically-enriched selenium comprising a selenium isotope selected from the group consisting of ⁷⁴Se, ⁷⁶Se, ⁷⁷Se, ⁷⁸Se, ⁸⁰Se and ⁸²Se.

57. A ZnSe lens having superior thermal conductivity comprising isotopically-enriched ZnSe isotope crystals selected from the group consisting of ⁶⁴Zn⁷⁴Se, ⁶⁴Zn⁷⁶Se, ⁴Zn⁷⁷Se, ⁶⁴Zn⁷⁸Se, ⁶⁴Zn⁸⁰Se, ⁶⁴Zn⁸²Se, ⁶⁶Zn⁷⁴Se, ⁶⁶Zn⁷⁶Se, ⁶⁶Zn⁷⁷Se, ⁶⁶Zn⁷⁸Se, ⁶⁶Zn⁸⁰Se, ⁶⁶Zn⁸²Se, ⁶⁷Zn⁷⁴Se, ⁶⁷Zn⁷⁶Se, ⁶⁷Zn⁷⁷Se, ⁶⁷Zn⁷⁸Se, ⁶⁷Zn⁸⁰Se, ⁶⁷Zn⁸²Se, ⁶⁸Zn⁷⁴Se, ⁶⁸Zn⁷⁶Se, ⁶⁸Zn⁷⁷Se, ⁶⁸Zn⁷⁸Se, ⁶⁸Zn⁸⁰Se, ⁶⁸Zn⁸²Se, ⁷⁰Zn⁷⁴Se, ⁷⁰Zn⁷⁶Se, ⁷⁰Zn⁷⁷Se, ⁷⁰Zn⁷⁸Se, ⁷⁰Zn⁸⁰Se and ⁷⁰Zn⁸²Se.

58. A method of producing a single crystal germanium lens with superior thermal conductivity comprising:
a. growing single crystals of germanium from isotopically-enriched germanium melts by the standard Czochralski method;
b. shaping said single crystals of germanium to lens specifications.

59. The method of claim 58, wherein said single crystals of germanium comprise a germanium isotope selected from the group consisting of ⁷⁰Ge, ⁷²Ge, 73Ge, ⁷⁴Ge and ⁷⁶Ge.

60. The method of claim 58, wherein said germanium isotope is enriched to greater than 90%.

61. The method of claim 58, wherein said germanium isotope is enriched to greater than 95%.

62. The method of claim 58, wherein said germanium isotope is enriched to greater than 99%.

63. A germanium lens having superior thermal conductivity comprising an isotopically-enriched germanium isotope selected from the group consisting of ⁷⁰Ge, ⁷²Ge, ⁷³Ge, ⁷⁴Ge and ⁷⁶Ge.

64. A method of producing a gallium arsenic lens with superior thermal conductivity comprising:
a. growing single crystals of gallium arsenide from isotopically-enriched gallium melts by the standard Czochralski method;
b. shaping said single crystals of gallium arsenic to lens specifications.

65. The method of claim 64, wherein said single crystals of gallium arsenide comprise a gallium isotope selected from the group consisting of ⁶⁹Ga and ⁷¹Ga.

66. The method of claim 65, wherein said gallium isotope is enriched to greater than 90%.

67. The method of claim 65, wherein said gallium isotope is enriched to greater than 95%.

68. The method of claim 65, wherein said gallium isotope is enriched to greater than 99%.

69. A gallium arsenide lens having superior thermal conductivity comprising an isotopically-enriched gallium isotope selected from the group consisting of ⁶⁹Ga and ⁷¹Ga.
